(19) United States
(12) Patent Application Publication
(10) Pub. No.: US 2007/0282805 A1
(43) Pub. Date: Dec. 6, 2007

(54) Apparatus and method for comparing metadata structures

(75) Inventor: Douglas Stuart Janzen, Vancouver (CA)

Correspondence Address: COOLEY GODWARD KRONISH LLP;ATTN: Patent Group, Suite 1100, 777 - 6th Street, NW, Washington, DC, 20001, US

(73) Assignee: Business Objects, S.A., Levallois-Perret (FR)

(21) Appl. No.: 11/445,488

(22) Filed: May 31, 2006

(51) Int. Cl. G06F 17/30

(52) U.S. Cl. 707/3

(57) ABSTRACT

A computer readable medium has executable instructions to access a first question domain with first object definitions and a second question domain with second object definitions. Differences between the second object definitions and the first object definitions are identified. Severity values characterizing the differences are determined. A list of the differences and corresponding severity values is compiled.

### BRIEF DESCRIPTION OF THE INVENTION

This invention relates generally to accessing digital data. More particularly, this invention relates to comparing metadata structures wherein the metadata structures are configured to facilitate transforming text questions into database queries.

### BACKGROUND OF THE INVENTION

Business Intelligence generally refers to software tools used to improve business enterprise decision-making. These tools are commonly applied to financial, human resource, marketing, sales, customer, and supplier analyses. More specifically, these tools can include: reporting and analysis tools to present information; content delivery infrastructure systems for delivery and management of reports and analytics; data warehousing systems for cleansing and consolidating information from disparate sources; and, data management systems, such as relational databases or On Line Analytic Processing (OLAP) systems used to collect, store, and manage raw data.

Given the disparate roles performed by Business Intelligence tools and the vast amount of data that they are applied against, there are ongoing efforts to simplify their use. In their most successful manifestations, non-technically trained personnel can use Business Intelligence tools. To achieve this, it is important to insulate non-technically trained personnel from the complexities of the underlying data sources. Users of Business Intelligence tools generally have knowledge of the information that they want; the challenge is translating this knowledge into appropriate queries that can be applied to an underlying data source.

Ideally, a Business Intelligence tool provides an interface that allows a user to think on his or her own terms, but still allows for data source queries (e.g., database queries) that can be efficiently applied against a data source. Metadata is often used in strategies to simplify access to a data source, but often this metadata adds another level of complexity rather than providing accessible conceptual metaphors that can be readily understood by novice end users without learning about the logical structure of the metadata. Since Business Intelligence users commonly think in terms of subjects (such as products, employees, stores, regions), behaviors (such as selling, buying, shipping, hiring, responding, owing), and measures (such as revenue, units sold, quantity invoiced, profit) it would be desirable to provide such users with a metadata framework that allows them to select specific meaningful subjects, behaviors, and measures in order to shape how they create high level questions to access a data source or multiple data sources. Ideally, such a system would enable the creation of shared metadata domains that would enable a novice end user to construct a range of high level seemingly straightforward business questions against multiple underlying data sources without requiring that the novice end user understand the structure or complexity of the underlying data.

As disclosed in the Applicant's co-pending U.S. patent application Ser. No. 11/102,477 the contents of which are hereby incorporated by reference in their entirety, business intelligence tools are known in the art which allow users to associate text sentence components with metadata by specifying subjects and behaviors that have definitions corresponding to one or more metadata sources. Each behavior is associated with at least one subject. Each behavior and at least one subject allow a user to create a text question convertible to a query to a data source associated with the metadata source.

In order to facilitate business intelligence tools such as these, a category of metadata structures based on the concepts of subject, behavior, and measure have been proposed, including a process to construct these metadata structures. Such metadata structures may then be used and re-used in other applications by novice end users to share a foundation for constructing a wide range of queries based on an accessible logical structure. These queries based on the metadata can then be used to query the data source and perform further functions, such as generating reports.

These metadata structures (or question domains) are based on a set of easily understood logical relationships (e.g., subject, behavior, and measure). An intermediate user who has some understanding of the data content in the underlying data sources, but who does not have programming skills (e.g., SQL programming skills) may create a question domain. This intermediate user is guided by a graphical user interface (GUI) that provides logical information based on the contexts and constraints in the underlying data source and enables the intermediate user designing the question domain to construct subjects, behaviors, and measures. In this way, the question domain designer's knowledge about the underlying data is encapsulated in subject, behavior, and measure relationships that can be readily understood by more novice users who do not have knowledge about the underlying data source. Question domains can be saved locally or be published within repository systems. They can also be easily updated and republished. Based on the question domain that has been designed, novice end users are able to easily construct a wide range of business questions with no knowledge of the specifics of the underlying data.

A question domain is constructed on top of a data source, referred to as a Primitive Metadata Domain or Primary Metadata Domain (PMD). The data source contains a layer of metadata that at a minimum should identify the data objects, table joins, aggregated measures, and optionally may identify date objects, table join sets (also called contexts) and filters. Examples of primary metadata domains that contain the required metadata include Business Objects Universes or Business Views, which are commercially available from Business Objects Americas, San Jose, Calif. In the case of a data source, such as a relational database schema, that does not contain this metadata, an intermediary adapter layer is constructed. In a question domain, a subject may be connected to one or more such primary metadata domains, however each behavior is associated with a single underlying primary metadata domain.

Since it is possible for multiple question domains to be created on top of one or more primary metadata domains, and for multiple question domains to be stored in multiple locations on a computer network, or on local computers which may be connected to a network, it would be advantageous to provide a tool to compare one question domain to another. In particular, in business intelligence tools which allow decentralized storage and management of queries on a first computer that references a question domain which may be stored on a second computer, it would be advantageous to provide a tool to identify changes made to a question domain which may affect the result of a possible query that may be stored on the first computer. A tool capable of identifying changes made to a question domain may also be advantageous in order to provide an indication of the accuracy of data returned in response to a query that references the question domain.

### SUMMARY OF THE INVENTION

The invention includes a computer readable medium with executable instructions to access a first question domain with first object definitions and a second question domain with second object definitions. Differences between the second object definitions and the first object definitions are identified. Severity values characterizing the differences are determined. A list of the differences and corresponding severity values is compiled.

### BRIEF DESCRIPTION OF THE DRAWINGS

The invention is more fully appreciated in connection with the following detailed description taken in conjunction with the accompanying drawings, in which:

FIG. 1 illustrates a computer constructed in accordance with an embodiment of the invention.

FIG. 2 illustrates a general flow of process operations configured in accordance with an embodiment of the invention.

FIG. 3 illustrates a flow of process operations in accordance with a user-oriented embodiment of the invention.

FIG. 4 illustrates a flow of comparison operations for a comparison process in accordance with an embodiment of the invention.

FIG. 5 illustrates a further flow of comparison operations for the comparison process of FIG. 4 in accordance with an embodiment of the invention.

FIG. 6 illustrates a flow of operations for a severity rating mapping step configured in accordance with an embodiment of the invention.

FIG. 7 illustrates a GUI used to modify and compare question domains in accordance with an exemplary embodiment of the invention.

FIG. 8 illustrates a GUI used to summarize and confirm or reject changes to a question domain in accordance with an exemplary embodiment of the invention.

FIG. 9 illustrates a question domain in accordance with an embodiment of the invention.

Like reference numerals refer to corresponding parts throughout the several views of the drawings.

### DETAILED DESCRIPTION OF THE INVENTION

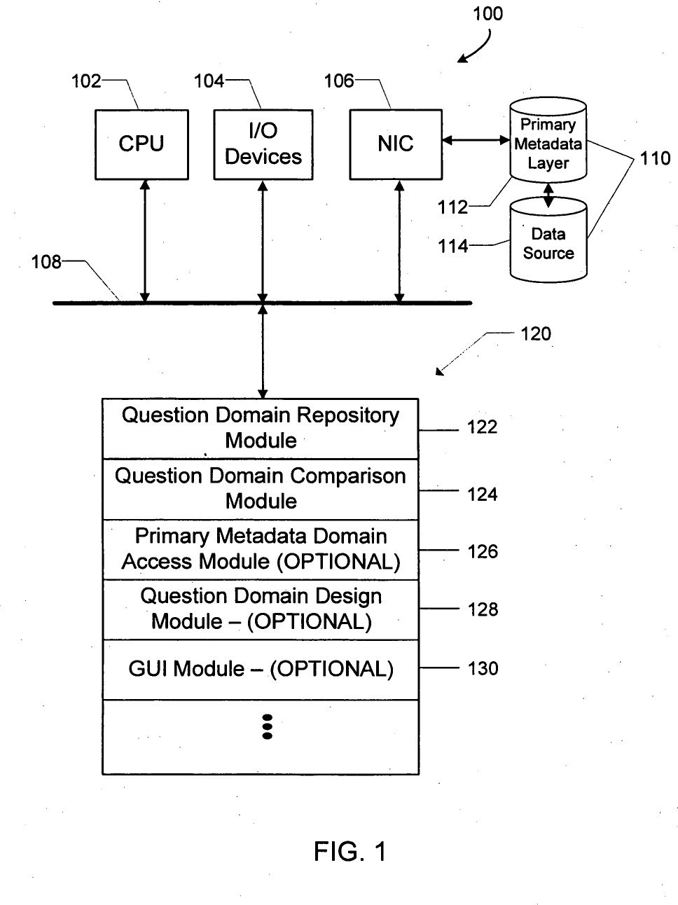

FIG. 1 illustrates a computer 100 configured in accordance with an embodiment of the invention. The computer 100 includes standard components, including a central processing unit 102 and input/output devices 104, which are linked by a bus 108. The input/output devices 104 may include for example a keyboard, mouse, touch screen, monitor, printer, and the like. A network interface circuit 106 is also connected to the bus 108. The network interface circuit 106 provides connectivity to a network, thereby allowing the computer 100 to operate in a networked environment. A networked primary metadata domain (PMD) 110 comprising data source 114 and primary metadata layer 112 may be connected to the computer 100 by means of the network interface circuit 106. In one embodiment, the data source 114 may comprise a database such as a relational database, commercially available examples of which include structured query language (SQL) based relational database management systems (RDMS). In one embodiment, the primary metadata layer 112 may be combined with the data source 114 as a primary metadata domain (PMD) 110, commercially available examples of which include Business Objects Universe and Business Views, available from Business Objects Americas, San Jose, Calif.

A memory 120 is also connected to the bus 108. The memory 120 stores executable instructions to implement operations of the invention. In one embodiment, the executable instructions include a question domain repository module 122. The question domain repository module 122 includes executable instructions to access and optionally to store question domains from and to a question domain repository (not shown). In some embodiments, the question domain repository may be stored in the memory 120 of computer 100 as part of the question domain repository module 122, or alternatively on a separate storage medium (not shown) connected to the computer 100 via the bus 108, or optionally via the network interface circuit 106.

Memory 120 also stores a question domain comparison module 124. The question domain comparison module 124 stores executable instructions to compare two or more question domains, and to determine differences between the question domains. The question domain comparison module 124 also stores executable instructions to determine severity ratings for any differences identified between question domains. The severity rating of a difference between two question domains is determined based on the relative potential effect of the difference on the value returned by a query based on one question domain compared to the other question domain.

Memory 120 may also store optional primary metadata domain access module 126. The optional primary metadata domain access module 126 stores executable instructions to access a primary metadata domain to allow the linking and/or importation of data and/or metadata stored in the primary metadata domain to a question domain. In one embodiment, the optional primary metadata domain module 126 may comprise instructions to access a networked primary metadata domain 110 via the network interface circuit 106. In another embodiment, primary metadata domain information may be locally stored on computer 100 such as on a suitable data storage medium connected to bus 108.

Memory 120 may also store optional question domain design module 128. The optional question domain design module 128 stores executable instructions comprising instructions to create or modify question domains. In one embodiment, creating and editing of question domains may comprise specifying one or more primary metadata domains as data sources, specifying question domain objects such as subjects, behaviors and measures, and associating such question domain objects with data and/or metadata, and with other question domain objects.

Memory 120 may also store optional GUI module 130. The optional GUI module 130 may rely upon standard techniques to produce graphical components, such as pull-down menus, radio buttons, and the like, examples of which are discussed below.

The optional primary metadata domain access module 126, and optional question domain design module 128 may be implemented in accordance with any number of techniques, including those described in the following previously filed, commonly owned patent applications, each of which is incorporated by reference herein: Apparatus and Method for Data Modeling Business Logic, Ser. No. 11/102,613, filed Apr. 7, 2005; Apparatus and Method for Utilizing Sentence Component Metadata to Create Database Queries, Ser. No. 11/102,477, filed Apr. 7, 2005; and Apparatus and Method for Constructing Complex Database Query Statements Based on Business Analysis Comparators, Ser. No. 11/102,562, filed Apr. 7, 2005.

The executable modules stored in memory 120 are exemplary. It should be appreciated that the functions of the modules may be combined. In addition, the functions of the modules need not be performed on a single machine. Instead, the functions may be distributed across a network, if desired. Indeed, the invention is commonly implemented in a client-server environment with various components being implemented at the client-side and/or the server-side. It is the functions of the invention that are significant, not where they are performed or the specific manner in which they are performed.

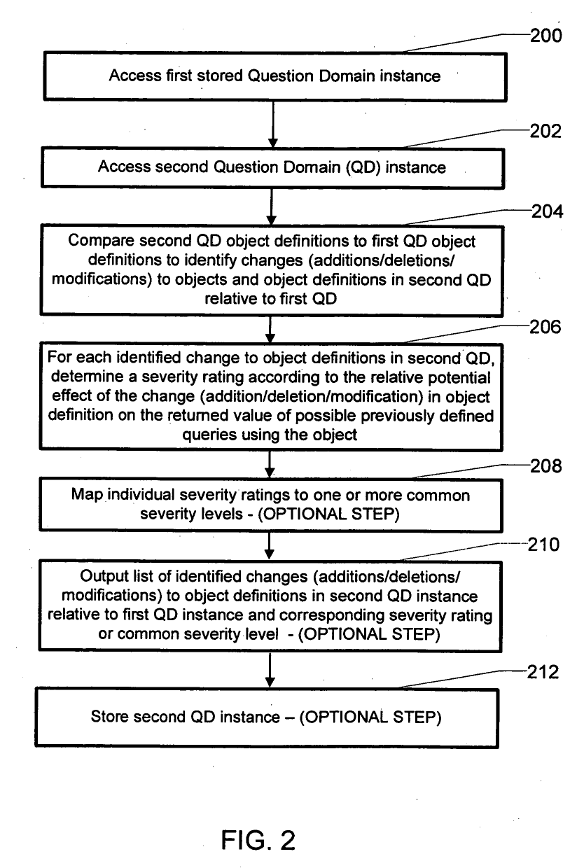

FIG. 2 illustrates processing operations that may be implemented by the computer 100, according to an embodiment of the present invention. The first processing operation of FIG. 2 is to access a first stored question domain instance 200. The question domain repository module 122 can be used to implement this operation within computer 100. In this first processing operation 200, the question domain repository module 122 is implemented to access a first question domain stored in a question domain repository. The first question domain may comprise one or more question domain objects, such as subject, behavior or measure objects, where each such object comprises an object definition.

The next operation of FIG. 2 is to access a second question domain instance 202. In one embodiment, the second question domain instance may be stored in a question domain repository, and in another embodiment, the second question domain instance may be stored in the memory 120 of computer 100, such as when the second question domain has been created or edited using the optional question domain design module 128. Similar to the first question domain above, the second question domain may comprise one or more question domain objects, such as subject, behavior or measure objects, where each object comprises an object definition.

The next operation of FIG. 2 is to compare the second question domain object definitions to the first question domain object definitions to identify changes (additions, deletions, or modifications) to the objects and object definitions of the second question domain, relative to the first question domain 204. The question domain comparison module 124 can be used to implement operation 204 within computer 100. Changes to the objects and object definitions of the second question domain relative to the first question domain may typically comprise additions of objects, deletion of objects and/or modification of object definitions. In one embodiment, any changes to the second question domain objects or object definitions which are identified in the comparison operation 204, may be logged in a list of changes. In such an embodiment, the list of changes may optionally be output to the memory 120 of the computer 100, or a suitable data storage medium such as a repository, or may be output to another location external to the computer 100.

The next operation of FIG. 2, operation 206, is to determine a severity rating for each change to objects and/or object definitions in the second question domain identified in operation 204, where the severity rating is determined according to the relative potential effect of the change (addition, deletion or modification) on the value returned by possible previously defined queries using objects in the changed second question domain. The question domain comparison module 124 can be used to implement operation 206. For any stored question domain, such as the first stored question domain referred to in operation 200, one or more possible previously defined queries may exist that use objects in the stored question domain. The value returned by a possible query that has been previously defined using objects in the first question domain may be affected by changes (additions, deletions and/or modifications) to those objects in the second question domain. For this reason, it is desirable that the relative potential effect of any change to an object definition (or the addition or deletion of an object) in the second question domain be determined, such as by the determination of a corresponding severity rating in this operation 206. In one embodiment, the severity rating determined for a given change in object definition may depend on the type of object and the property of the object definition that are changed (or the addition or deletion of the object), relative to the first question domain.

An optional additional operation of FIG. 2, operation 208, is to map individual severity ratings determined according to operation 206 to one or more common Severities. The question domain comparison module 124 can be used to implement operation 208. In one embodiment including optional operation 208, multiple individual severity ratings may be determined according to operation 206 for changes to objects and object definitions in the second question domain, and these multiple individual severity ratings can be mapped to one or more common severity levels. These common severity levels can be used to simplify the assessment of possible effects of changes to objects, by mapping individual severity ratings determined for different particular changes but that may have similar potential effects to a single common severity level.

A further optional operation of FIG. 2 is to output a list of identified changes (additions, deletions, and/or modifications) to object definitions in the second question domain instance relative to the first question domain instance and corresponding severity ratings or common severity levels 210. The question domain comparison module 124 can be used to implement operation 210. In one embodiment, the optional GUI module 130 may also be used to output the list of identified changes in a graphical format.

A final optional operation of FIG. 2 is to store the second question domain instance 212. The question domain repository module 122 can be used to implement operation 212, storing the second question domain instance 212 as part of module 122, or in a question domain repository.

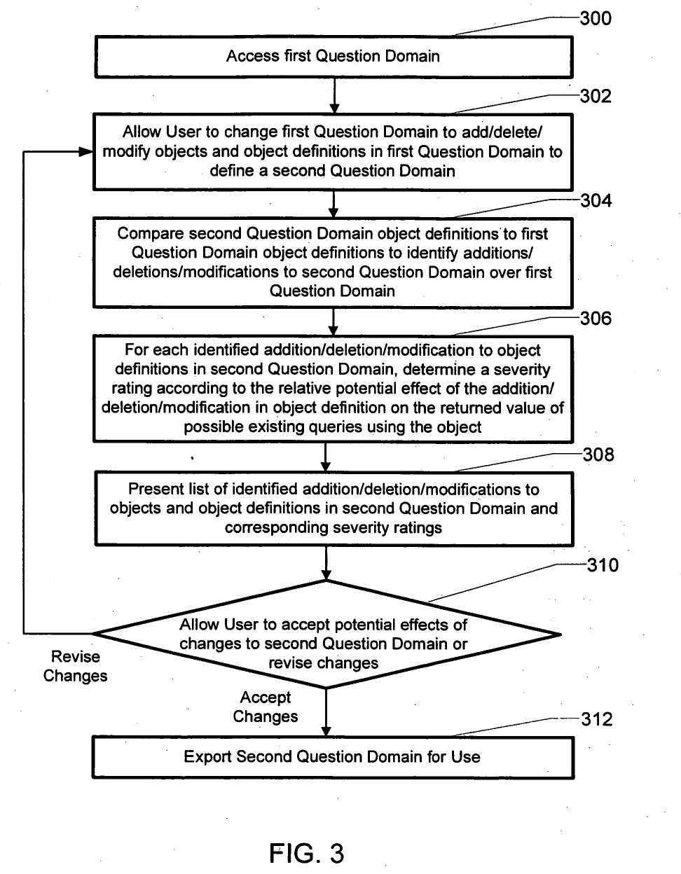

FIG. 3 illustrates a user-oriented process that may be implemented by the computer 100 according to an embodiment of the invention. The first processing operation of FIG. 3 is to access a first stored question domain 300. The question domain repository module 122 can be used to implement this operation, such as by accessing the first stored question domain from a question domain repository. The accessed first question domain may typically comprise one or more question domain objects, such as subject, behavior or measure objects, where each such object may comprise an object definition.

The next operation of FIG. 3 is to allow a user to change the first question domain to add, delete, or modify objects and object definitions to define a second question domain 302. The question domain design module 128 can be used to implement this operation. The GUI module 130 may also be used in combination with the question domain design module 128, to provide a graphical format for the user to change the first question domain such as by means of standard techniques and graphical components, examples of which are discussed below.

The next operation of FIG. 3 is to compare the second question domain object definitions to the first question domain object definitions to identify changes (additions, deletions, or modifications) to the objects and object definitions of the second question domain, relative to the first question domain 304. The question domain comparison module 124 can be used to implement operation 304. Changes to the objects and object definitions of the second question domain over the first question domain typically comprise additions of objects, deletion of objects and/or modification of object definitions of an object. In one embodiment, any changes to the second question domain objects or object definitions which are identified in the comparison operation 304, are logged in a list of changes, which may optionally be output to the memory 120 of the computer 100, or other storage medium, or may be passed as a parameter to another process within the computer 100.

The next operation of FIG. 3, operation 306, is to determine a severity rating for each change to object definitions in the second question domain identified in operation 304, where the severity rating is determined according to the relative potential effect of the change (addition, deletion or modification) in object definition on the value returned by possible existing queries using the changed object. Similar to operation 206 above, the question domain comparison module 124 can be used to implement operation 306. Optionally, the processing operations of FIG. 3 may additionally comprise a severity rating mapping operation such as operation 208 in FIG. 2 following operation 306, to map multiple individual severity ratings to one or more common severity levels.

The next operation of FIG. 3 is to present a list of identified changes (additions, deletions and/or modifications) to objects and object definitions in the second question domain and corresponding severity ratings (and/or optionally common severity levels) 308. The question domain comparison module 125 can be used to implement operation 306. The GUI module 130 may also be used in combination with the question domain comparison module 124, to present the list of changes and corresponding severity ratings in a graphical format.

The next operation in FIG. 3 is to allow a user to accept the potential effects of changes to the second question domain, or to reject and revise such changes 310. The question domain design module 128, and/or the GUI module 130 can be used to implement this operation. If the user chooses to reject and revise the changes, the processing order may return to operation 302, as shown in FIG. 3. If the user chooses to accept the changes, the processing order may continue to the next operation 312 as shown in FIG. 3.

The final operation in FIG. 3 is to export the second question domain for use 312. The question domain repository module 122 can be used to implement operation 312, exporting the second question domain for storage as part of module 122, or alternatively in a question domain repository.

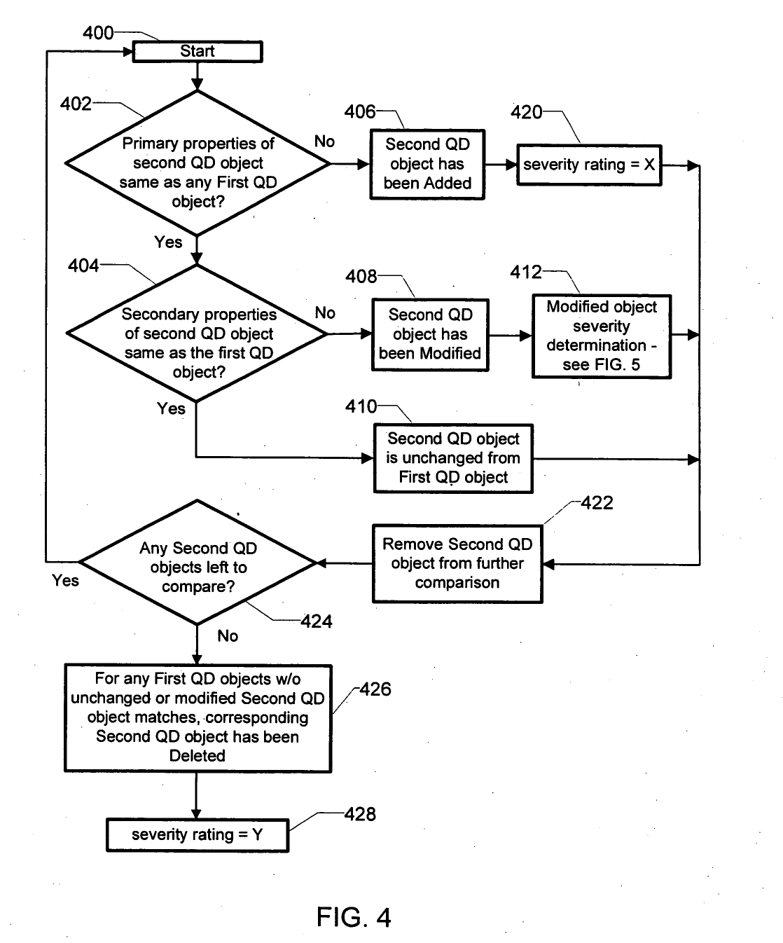

FIG. 4 illustrates a process to compare a second question domain to a first question domain based on matching of primary properties of objects in the question domains, and of secondary properties of such objects, according to an embodiment of the present invention. The question domain comparison module 125 can be used to implement the process of FIG. 4. For the purposes of the following comparison steps 402 and 404, question domain objects comprise an object definition, which comprises one or more primary properties, and one or more secondary properties. Particular question domain object properties can be classified as primary or secondary according to their importance to the identification and/or use of the question domain object in a particular question domain schema. In one embodiment, question domain objects comprise object definitions which comprise various properties: name, ID, description, and at least one data attribute. In this embodiment, the name and/or ID properties are classified as primary properties, and the description and at least one data attribute properties are classified as secondary properties. While in some cases multiple types of question domain objects (such as for example subject, behavior, or measure type objects) may comprise the same classification of which properties are primary or secondary properties, in general, each object type may have different properties classified as primary or secondary.

The process of FIG. 4 starts at the “Start” block 400, where one of the second question domain objects is selected for comparison. Next, one or more primary properties of the selected second question domain object are compared with one or more primary properties of each first question domain objects in comparison block 402. If the one or more primary properties of the selected second question domain object do not match any of the primary properties of a first question domain object then the second question domain object is concluded to have been added relative to the first question domain in process block 406, and a corresponding severity rating=X is determined 420 for an added second question domain object.

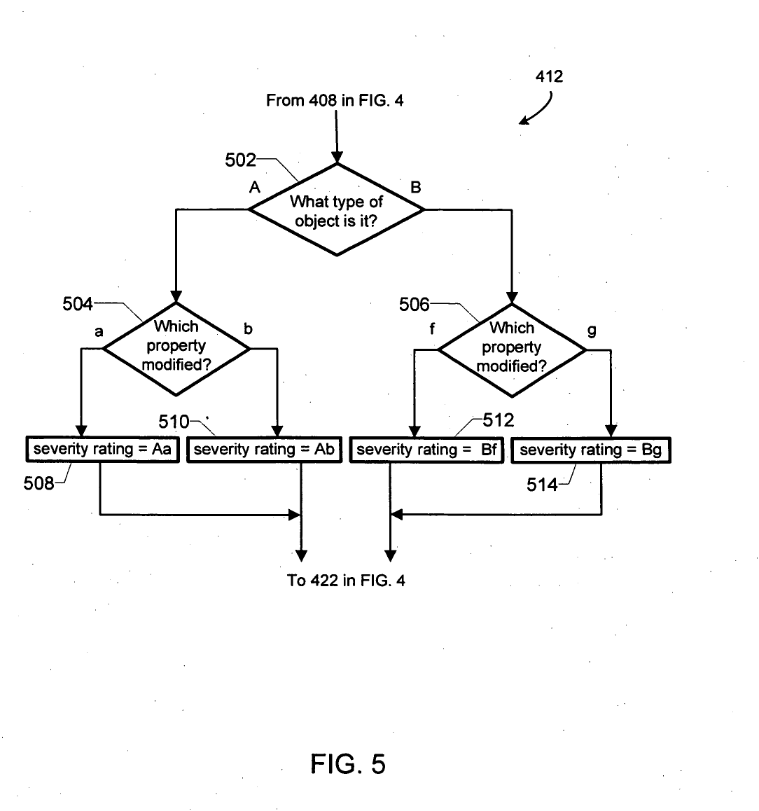

If the one or more primary properties of the selected second question domain match those of a first question domain object (402—YES), then the one or more secondary properties of the selected second question domain object are compared with the secondary properties of the matching first question domain object in comparison operation 404. If the one or more secondary properties of the selected second question domain object are not the same as those of the matching first question domain object, then the second question domain object is concluded to have been modified relative to the first question domain 408, and a severity rating corresponding to the modification of the selected second question domain object is be determined according to the modified object severity determination process 412, which is illustrated and described below in FIG. 5.

If the one or more secondary properties of the selected second question domain object are equal to the matching first question domain object in step 404, then the selected second question domain object is determined to be unchanged from the first question domain 410.

Following the determination of whether the selected second question domain object is added, modified or unchanged relative to the first question domain, in 406, 408 and 410 respectively, the selected question domain object is then removed from further comparison 422. Following the removal of the previously selected second question domain object 424, it is determined if there are any remaining second question domain objects left to compare. If so, the process returns to the start 400. If there are no remaining second question domain objects, any first question domain objects that do not have matching primary properties with modified or unchanged second question domain objects are identified 426, and missing second question domain objects which would correspond to such unmatched first question domain objects are determined to have been deleted from the second question domain. A corresponding severity rating=Y is determined 428 for each such “deleted” second question domain object. It may be noted that in an optional embodiment, there may be multiple severity ratings corresponding to a deleted object, whereby the particular severity rating determined for the deletion of a second question domain object depends upon the kind of object which was deleted. Similarly, in another optional embodiment, there may be multiple severity ratings corresponding to an added object, and the particular severity rating determined for the addition of a second question domain object depends upon the kind of object that was added.

FIG. 5 illustrates a simplified modified object severity determination process 412 to determine a severity rating corresponding to a change in a second question domain object that has been modified from a first question domain object, according to an embodiment of the invention as referenced in FIG. 4. The question domain comparison module 125 can be used to implement process 412. After a selected second question domain object has been determined to have been modified in 408, the kind of the selected object is determined 502. In the present embodiment, the kind of object is selected from two exemplary choices, A and B. If the selected object is determined to be of kind A, the property of the selected object which was modified relative to the matching first question domain object is determined 504. In the present embodiment, for an object A, the modified property is selected from two exemplary properties a and b. In the case that property a was modified in a selected object of kind A, a corresponding severity rating=Aa is determined 508. Conversely, if property b was modified in a selected A object, a corresponding severity rating=Ab is determined 510.

Similarly, if the selected object is determined to be of kind B, the property of the selected object which was modified is determined 506. In the present embodiment, for an object B, the modified property is selected from two exemplary properties f and g. In the case that property f was modified in a selected object of kind B, a corresponding severity rating=Bf is determined 512. Conversely, if property g was modified in a selected B object, a corresponding severity rating=Bg is determined in 514.

In one embodiment of the invention, kinds of question domain object comprise subject, behavior, and measure objects. Each kind of object may comprise one or more properties, and may typically comprise multiple properties. As an example, in the current embodiment, a subject object may comprise name, ID, description, and data attribute properties. Similarly, a behavior object may comprise name, ID, description, measure and data attribute properties, and a measure object may comprise name, ID, description and data attribute measures. Therefore, in the current embodiment, the object kind determination step 502 of the process 412 may comprise three potential kinds of objects corresponding to subject, behavior and measure objects. Similarly, each kind of object may comprise multiple potential modified property options in 504, such as four property options in the case of subject objects (name, ID, description, and data attribute properties). In this manner, a multiplicity of potential individual severity ratings each corresponding to a single modified property within a single kind of object are possible to represent the relative potential effect on the value returned by a possible existing query of the modification of a particular property of a particular kind of object in a second question domain, as described above in reference to FIG. 2 and FIG. 3. Other possible kinds of question domain objects include objects which define relationships between other objects, such as subject-behavior objects, which define relationships between subject objects and behavior objects.

In the particular embodiment of FIG. 5, the selected second question domain is determined in block 502 to be either a subject, A, or a behavior object, B. If the selected object is a subject object, A, the subject object property that was modified relative to the matching first question domain object is determined in block 504 to be either a change in subject name property, a, or a change in subject description property, b. In the case of a change in subject name property, a, a warning severity rating Aa is established in block 508. In the case of a change in subject description property, b, an OK severity rating Ab is established in block 510. Similarly, if the selected object is a behavior object, B, the behavior object property that was modified relative to the matching first question domain object is determined in block 506 to be either a change in behavior name property, f, or a change in behavior PMD property, g. In the case of a change in behavior name property, f, a warning severity rating Bf is established in block 512. In the case of a change in PMD property, g, a conflict severity rating Bg is established in block 514.

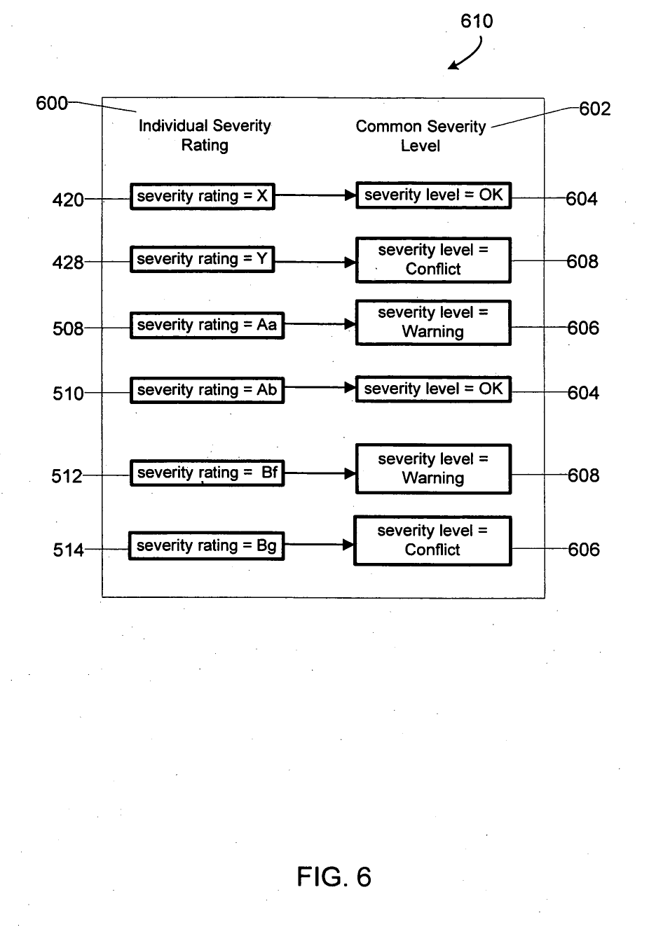

FIG. 6 illustrates a process 610 that may be implemented to map multiple individual severity ratings 600 to one or more common severity levels 602, according to an embodiment of the present invention. The question domain comparison module 125 can be used to implement process 610. According to mapping process 610, exemplary severity ratings 420, 428, 508, 510, 512, and 514 determined by the comparison process of FIG. 4 and the modified object severity determination process of FIG. 5 may be mapped to exemplary common severity levels 604, 606, and 608. In such a manner, individual severities 600 which are determined to represent similar potential effects of a change to a second question domain on the value returned by a potential existing query may be mapped to a common severity level 602 which may be stored or presented.

For example, in the embodiment depicted in FIG. 6, three common severity levels “OK” 604, “Warning” 606 and “Conflict” 608 are adopted to represent the relative potential effect on existing query results of the individual exemplary severity ratings X 420, Y 428, Aa 508, Ab 510, Bf 512 and Bg 514, as defined above. These three common severity levels may advantageously be used to represent to a user the potential effect on existing query results, and can be more easily understood than a recitation of the multiple individual severity ratings.

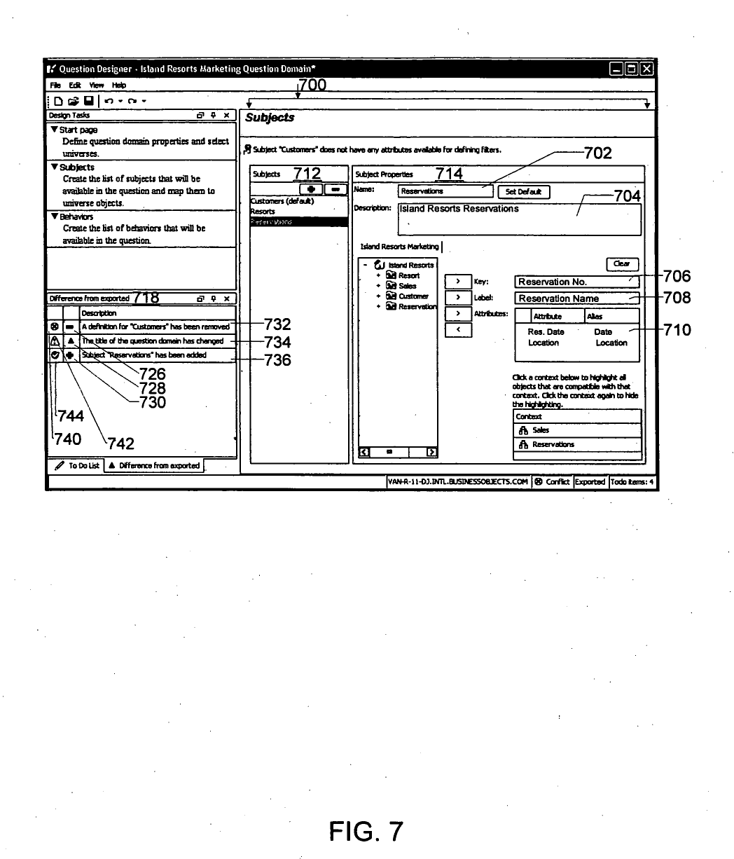

FIG. 7 illustrates a graphical user interface (GUI) used to implement an embodiment of the present invention. The GUI depicted in FIG. 7 comprises a subject object properties panel 700 which displays the properties of one or more subject objects of a question domain. The subject object currently displayed is selected from the list of subject objects in the subject selection toolbar 712. Similarly, subject objects may be added or deleted by use of the plus and minus buttons on the subject selection toolbar 712. The properties of the currently selected object are displayed in the subject properties panel 714. These subject object property fields comprise name 702, description 704, key 706, label 708, and data attributes 710. These properties may be added, deleted and/or modified by a user by changing the values in the property fields. For the exemplary illustrated subject objects, the name property 702 is designated as a primary object property, and the description 704, key 706 and label 708 properties are designated as secondary object properties. Similar object property panels may be used to display and add/delete/modify properties of other kinds of objects possible in question domains such as behavior, or measure objects, for example.

Using the GUI depicted in FIG. 7, a user can access a first question domain, and add, delete and/or modify objects and object definitions (comprising one or more object properties) to define a second question domain. The “Difference from Exported” object comparison panel 718 in the GUI of FIG. 7 displays a list of changes that have been made to the first question domain accessed by the user, as modified in the GUI object properties panel(s). The exemplary object comparison panel 718 displays a list of the changes between the second question domain and the first question domain, comprising descriptions of the changes 732, 734 and 736, the type of changes made 726, 728 and 730, and the corresponding severity levels 740, 742 and 744.

The object comparison panel 718 currently displays a Conflict severity level symbol (X) 740 corresponding to the description “A definition for “Customers” has been removed” 732 and a deletion change symbol “−” 726 to indicate that a primary metadata domain definition for the subject object “Customers” has been deleted from the second question domain. Object Comparison panel 718 also displays a Warning severity level symbol (!) 742 corresponding to the description “The title of the question domain has changed” 734 and a modification change symbol “Δ” 728. Finally, the object comparison panel 718 displays an OK severity level symbol (√) corresponding to the description “Subject “Reservations” has been added” 736 and an addition change symbol “+” 730 to indicate that a subject object named “Reservations” has been added to the second question domain. These indications of changes to the second question domain compared to the first question domain and corresponding severity levels are displayed in the GUI of FIG. 7 on a real-time basis as changes are made to the second question domain. However, in another embodiment, the indications of changes in the object comparison panel 718 may be presented in a summary form at the end of the question domain change process.

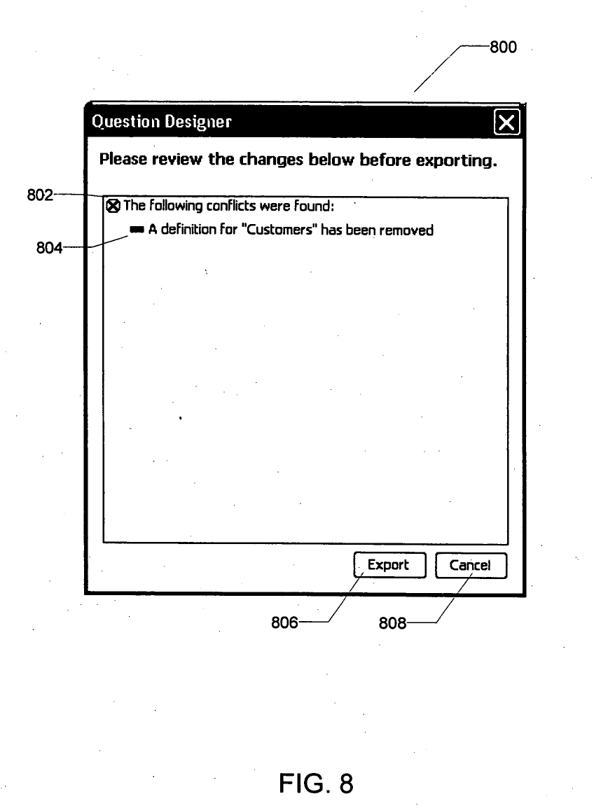

FIG. 8 illustrates a graphical user interface (GUI) used to implement a further embodiment of the present invention. The GUI depicted in FIG. 8 illustrates a question domain change summary dialog box 800 which may be displayed following the modification of a first question domain to define a second question domain. The question domain change summary dialog box 800 presents a list of changes between the second question domain and the first question domain, comprising a description of the change, the kind of change (addition or deletion of an object or modification of an object definition), and a corresponding severity level representing the potential effect of the change on the value returned by a possible existing query using the changed object. The question domain change summary dialog box 800 currently displays a Conflict severity level symbol (X) 802 corresponding to a change description 804 reciting “A definition for “Customers” has been removed” and a deletion change symbol “−” indicating that a primary metadata domain definition for the Customers object has been deleted from the second question domain.

The question domain change summary dialog box 800 also presents the option to accept the indicated changes to the second question domain, and the corresponding potential effects, by selecting the “Export” button 806 which will store the changed second question domain to a repository or other data storage medium, or to reject the changes, and continue revising the second question domain, by selecting the “Cancel” button 808.

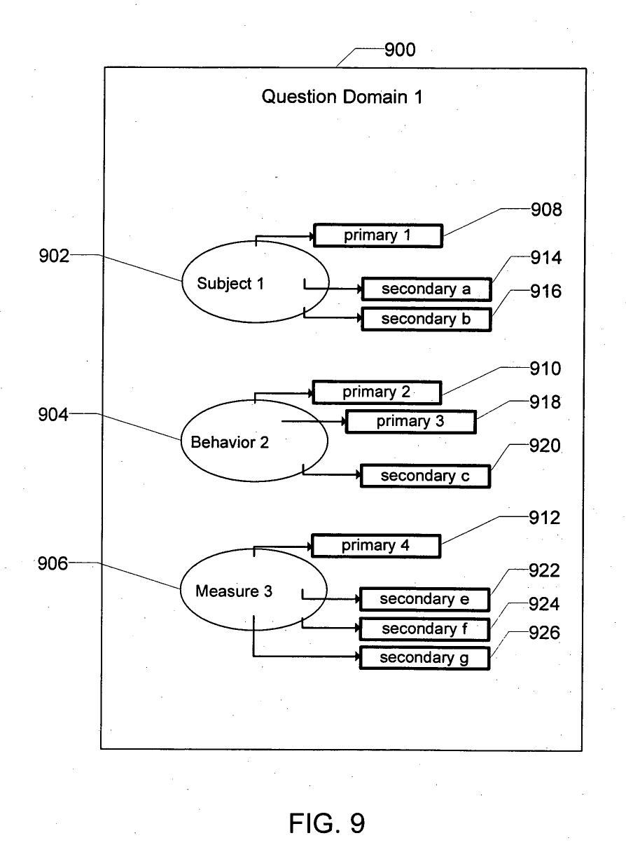

FIG. 9 illustrates a question domain 900 according to an embodiment of the invention. Question domain 900 comprises three objects including subject object “Subject 1” 902, behavior object “Behavior 2” 904 and measure object “Measure 3” 906. Subject object 902 comprises a primary property 908, and two secondary properties 914 and 916. Collectively, the primary and secondary properties 908, 914, 916 comprise the object definition of subject object 902. Similarly, behavior object 904 comprises two primary properties 910 and 918, and one secondary property and 920, which collectively comprise the object definition of behavior object 904, and measure object 906 comprises primary property 912 and secondary properties 922, 924 and 926. It should be noted that in alternative embodiments, a question domain may comprise any number of objects, which may themselves comprise at least one primary property and any number of secondary properties.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable medium, comprising executable instructions to:
access a first question domain with first object definitions and a second question domain with second object definitions;
identify differences between the second object definitions and the first object definitions;
determine severity values characterizing the differences; and
compile a list of the differences and corresponding severity values.

2. The computer readable medium of claim 1 wherein the first and second question domains comprise first and second metadata structures.

3. The computer readable medium of claim 1 wherein the first question domain is stored in a repository, and wherein the second question domain is a modified version of the first question domain.

4. The computer readable medium of claim 2 wherein the first and second object definitions comprise definitions of objects selected from the list comprising subject, behavior and measure objects.

5. The computer readable medium of claim 1 additionally comprising executable instructions to map at least one severity value to a severity group.

6. A computer readable medium, comprising executable instructions to:
access a first question domain;
allow a user to change one or more first object definitions of the first question domain to define second object definitions of a second question domain;
identify differences between the second object definitions and the first object definitions;
determine severity values corresponding to the differences; and
output a list of the differences and corresponding severity values.

7. The computer readable medium of claim 6 further comprising executable instructions to:
allow the user to select from one or more options selected from the list comprising: accepting the second object definitions, rejecting the second object definitions, and further changing one or more first object definitions of the first question domain to define the second object definitions of the second question domain.

8. The computer readable medium of claim 6 additionally comprising executable instructions to:
store the second question domain comprising the second object definitions.

9. The computer readable medium of claim 6 wherein the first and second object definitions comprise definitions of objects selected from the list comprising subject, behavior and measure objects.

10. The computer readable medium of claim 6 wherein the list of identified differences and corresponding severity values is output to a user in real-time, as the user changes a first object definition to define a second object definition.
